(19) United States
(12) Patent Application Publication
(10) Pub. No.: US 2022/0048824 A1
(43) Pub. Date: Feb. 17, 2022

(54) METHOD FOR CONDITIONING AN ACID WASTE BY CEMENTATION

(71) Applicants: ORANO DEMANTELEMENT, Chatillon (FR); UNIVERSITE GUSTAVE EIFFEL, Marne-la-Vallée cedex 2 (FR)

(72) Inventors: Lavinia Stefan, Saint Germain En Laye (FR); Thierry Chaussadent, Paris (FR); Mathieu Le Rouzic, Champigny-Sur-Marne (FR)

(21) Appl. No.: 17/414,651

(22) PCT Filed: Dec. 10, 2019
(86) PCT No.: PCT/FR2019/053005

§ 371 Date: Jun. 16, 2021

(30) Foreign Application Priority Data
Dec. 18, 2018 (FR) 1873254

(51) Int. Cl. C04B 28/34; G21F 9/16; B09B 3/00; C04B 40/06

(52) U.S. Cl. CPC C04B 28/344; G21F 9/165; C04B 2111/00767; C04B 40/0658; B09B 3/0041

(57) ABSTRACT

A method for conditioning an acid waste by cementation, wherein the acid waste is chosen among liquids having a pH of no more than 4, semi-liquids having a pH of no more than 4, solids of which the partial or full dissolution in water leads to a solution or suspension having a pH of no more than 4, and mixtures thereof, which method comprises the steps of: a) preparing a cement paste having as components at least: a magnesium phosphate cement and the acid waste, and b) hardening the cement paste thus obtained, and is characterised in that in step a), the cement paste is prepared without subjecting beforehand the acid waste to any treatment consisting in reducing the acidity thereof.

### TECHNICAL FIELD

The invention relates to the field of conditioning waste by cementation, i.e. by incorporation in a cement matrix.

More specifically, it relates to a method for conditioning an acid waste by cementation, this waste possibly being a liquid waste such as an aqueous effluent, a semi-liquid waste such as a sludge, or a solid waste such as rubble, or a mixture thereof.

The invention finds particular application in the conditioning of acid waste produced by the nuclear industry and hence contaminated or potentially contaminated by radioelements, such as:
acid waste derived from processes implemented in the nuclear fuel cycle and, in particular, for the mining extraction of uranium, the conversion and enriching thereof, the production of fresh nuclear fuels and the treatment of spent nuclear fuels;
acid waste derived from decontamination operations of nuclear cycle equipment and plants, or of nuclear reactors;
acid waste derived from remediation and dismantling operations of nuclear plants; and
mixtures thereof.

However, it can evidently be advantageously used to condition any other type of acid waste irrespective or origin (acid waste from the chemical industry, agri-food industry, test laboratories, etc.).

### State of the Prior Art

The conditioning of hazardous waste, nuclear waste in particular, by cementation is a conditioning method which has numerous benefits including simple implementation and relatively low cost (when compared with the costs of other conditioning methods).

The cementing of a waste involves the mixing of this waste with a cement material.

Cement materials containing hydraulic cements such as Portland cements, or containing blast furnace slag, which are conventionally used to cement waste, are highly basic materials.

The direct mixing of an acid waste with this type of material is difficult, even impossible, to carry out on account of the heat generated by the acid-base reaction, this heat being stronger the higher the acidity of the waste.

This is the reason why the state of the art recommends prior neutralisation of waste acidity by mixing the waste with sodium hydroxide (NaOH) and/or calcium hydroxide (Ca(OH)₂) to prevent or at least limit the heat generated by the acid-base reaction (cf. for example C. Utton and I. H. Godfrey, Report by the National Nuclear Laboratory NNL (09) 10212, 29 Jan. 2010, hereafter reference [1]).

However, this neutralisation has a certain number of drawbacks which are greater the higher the acidity of the waste, such as:
mixing of the acid waste with the neutralising agent itself produces heat which must be controlled;
neutralisation of the acidity of the waste lengthens implementation of the waste cementing process, in particular if mixing of the acid waste with the neutralising agent has to be carried out slowly to limit the heat produced by this mixture;
neutralisation of the acidity of the waste generates an increase in the volume of waste to be cemented as a result of the addition of neutralising agent; and
the presence of a neutralising agent in the cement material can have a negative impact on the behaviour of this material; for example, it has been shown that the presence of NaOH quickens the hydrating kinetics of the cement material, increases the reaction heat of the cement material and increases shrinkage thereof, whilst the presence of Ca(OH)₂ leads to a drop in the mechanical performance thereof.

There has been proposed in International application PCT WO 2004/075207, hereafter [2], a method for conditioning nuclear waste and in particular acid waste contaminated by actinides and/or transuranics, by cementation in a matrix of magnesium phosphate cement developed by Argonne National Laboratory under the trade name Ceramicrete™.

In this method also, provision is made for prior treatment of the acid waste by mixing the latter with magnesium oxide (MgO), which is one of the two components of Ceramicrete™, to bring the pH to a value of at least 5, and then mixing the waste with the components of the cement material.

Here too, this prior treatment intended to neutralise the acidity of the waste is both time- and energy-consuming, since the acid waste must be mixed slowly with the magnesium oxide to prevent the temperature of the resulting mixture being too high. For example, it is reported in Example 3 of reference [2], that to neutralise just 195 g of concentrated hydrochloric acid with 110.4 g of magnesium oxide—which corresponds to quantities far removed from those likely to be involved in waste cementation on an industrial scale—a time of 40 minutes is required.

Having regard to the foregoing, the inventors set themselves the objective of providing a method allowing acid waste and, more specifically, waste of high to very high acidity to be conditioned in a cement matrix, the method being free of any prior step to neutralise the acidity of this waste, without the absence of such neutralisation having a notable negative and/or uncontrolled impact on the setting of the cement material, on the reaction heat of this material and on the mechanical performance of the cement/waste composite obtained.

They further set themselves the objective that this method should be applicable to the manufacture of conditioning packages for acid waste, allowing a high incorporation rate of waste in a cement matrix with a view to minimising the number of conditioning packages for a given volume of waste.

As part of their work, the inventors have found that contrary to the teaching of reference [2], it is possible to incorporate highly to very highly acidic waste, such as concentrated nitric or sulfuric acid or sludge with high hydrofluoric acid content, in a magnesium phosphate cement material and directly, i.e. without a prior neutralisation step of the acidity of this waste, and without the setting of the cement material, the reaction heat of this material and the mechanical performance of the cement/waste composite being negatively and/or uncontrollably impacted.

It is upon these experimental findings that the invention is based.

### DESCRIPTION OF THE INVENTION

A first subject of the invention is therefore a method for conditioning an acid waste by cementation, the acid waste being selected from among liquids having a pH of no more than 4, semi-liquids having a pH of no more than 4, solids of which the partial or full dissolution in water leads to a solution or suspension having a pH of no more than 4, and mixtures thereof, which comprises the steps of:

a) preparing a cement paste having as components at least: a magnesium phosphate cement and the acid waste; and

b) hardening the cement paste thus obtained, and which is characterized in that at step a), the cement paste is prepared without the acid waste being subjected beforehand to any treatment consisting in reducing the acidity thereof.

In the invention, by “magnesium phosphate cement”, it is meant any cement composed of a source of oxidized magnesium, i.e. in oxidation state+II, this source typically being a magnesium oxide (MgO) calcined at high temperature (of “hard burnt” or “dead burnt” type), pure or containing impurities of type SiO₂, CaO, Fe₂O₃, AlO₃, etc, and a source of water-soluble phosphate, this source typically being a phosphoric acid salt.

It is recalled that this type of cement, that is typically prepared by mixing the source of oxidized magnesium (in powder form) with an aqueous solution comprising the water-soluble phosphate, leads to the formation of a cement material via reaction between the source of oxidized magnesium (which is basic) and the source of water-soluble phosphate (which is acid), said sources of oxidized magnesium and water-soluble phosphate reacting together at ambient temperature to form a cement paste which sets rapidly.

Among the magnesium phosphate cements, preference is given to the cements composed of:
a magnesium oxide such as those marketed by RICHARD BAKER HARRISON under references DBM 90 and DBM 95; and
a phosphoric acid salt and a metal such as aluminium phosphate (AlPO₄), aluminium hydrogen phosphate (Al₂(HPO₄)₃), aluminium dihydrogen phosphate (Al(H₂PO₄)₃), sodium phosphate (Na₃PO₄), sodium hydrogen phosphate (Na₂HPO₄), sodium dihydrogen phosphate (NaH₂PO₄), potassium phosphate (K₃PO₄), potassium hydrogen phosphate (K₂HPO₄) or potassium dihydrogen phosphate (KH₂PO₄), or a phosphoric acid salt and a non-metal such as ammonium phosphate ((NH₄)₃PO₄), diammonium hydrogen phosphate ((NH₄)₂HPO₄), ammonium dihydrogen phosphate (NH₄H₂PO₄) or ammonium polyphosphate ((NH₄)₃HP₂O₇), in a Mg/P molar ratio (magnesium/phosphorus) which is preferably between 1 and 12 and better still between 5 and 10.

Among these phosphoric acid salts, preference is given to potassium dihydrogen phosphate.

In addition to comprising the magnesium phosphate cement and the waste, the cement paste may comprise at least one admixture selected from among plasticizers (whether or not water-reducing), superplasticizers, setting retarders, and compounds which combine several effects such as superplasticizers/setting retarders, as a function of the workability, setting and/or hardening properties it is desired to impart to the cement paste.

In particular, the composition may comprise a superplasticizer and/or a setting retarder.

Superplasticizers that are particularly suitable are high water-reducing superplasticizers of polynaphthalene sulfonate type.

Setting retarders that are suitable are particularly hydrofluoric acid (HF) and the salts thereof (e.g. sodium fluoride), phosphoric acid (H₃PO₄) and the salts thereof (e.g. sodium phosphate), boric acid (H₃BO₃) and the salts thereof (e.g. sodium borate of borax type), citric acid and the salts thereof (e.g. sodium citrate), malic acid and the salts thereof (e.g. sodium malate), tartaric acid and the salts thereof (e.g. sodium tartrate), sodium carbonate (Na₂CO₃) and sodium gluconate.

Amongst these, preference is given to hydrofluoric acid, sodium fluoride, boric acid and sodium borate.

When the cement paste comprises a superplasticizer, this preferably does not represent more than 4.5% by mass of the total mass of this cement paste, whilst when the cement paste comprises a setting retarder, this preferably does not represent more than 10% by mass of the total mass of said cement paste.

According to the invention, the cement paste may additionally comprise:
sand, for example of the type marketed by SIBELCO under reference CV32, in which case the cement paste is called a mortar and the sand/cement mass ratio can reach 6; and/or
gravel, in which case the cement paste is called a concrete and the gravel/cement mass ratio can range up to 4.

The terms “sand” and “gravel” are to be construed in the usual acceptance thereof in the field of mortars and concretes (cf. in particular standard NF EN 12620 concerning aggregates for concrete), namely that:
sand is an aggregate of which the upper sieve size D is no more than 4 mm; whilst
gravel is an aggregate of which the lower sieve sized is at least 2 mm and the upper sieve size D is at least 4 mm, on the understanding that in the present invention the upper sieve size D of the gravel is preferably no more than 16 mm.

According to the invention, the cement paste typically comprises a water/magnesium phosphate cement mass ratio ranging from 0.10 to 1, preferably from 0.20 to 0.60 and better still from 0.30 to 0.55.

The water contained in the cement paste can come in full or in part from the acid waste if the latter is liquid, a semi-liquid waste or a solid waste that has previously been wetted. Therefore, the amount of mixing water which can be added to the magnesium phosphate cement and acid waste when preparing the cement paste is preferably adjusted taking into consideration the water content of the acid waste.

The preparation of the cement paste, or step a), can be conducted in several manners, in particular as a function of the form of the acid waste: liquid, semi-liquid or solid, and for a solid waste whether it is dry or wetted.

Therefore, for example, in a first embodiment of the method, step a) comprises the sub-steps of:

i) loading the magnesium phosphate cement and water into a container and mixing the cement and water until a homogeneous mixture is obtained;

ii) adding the acid waste in dry, wetted, semi-liquid or liquid form to the container; and simultaneously or successively

iii) mixing the mixture obtained at sub-step i) with the acid waste until homogenisation, whereby the cement paste is obtained.

It is to be noted that the source of water-soluble phosphate, which is contained in the magnesium phosphate cement, and the water can be added to the container separately or in the form of a solution previously prepared by dissolving the phosphate source in this water.

If one or more admixtures and/or sand and/or gravel are to be used, these can be added to the container at the same time as the magnesium phosphate cement and the water, and can be mixed with the cement and the water at sub-step i).

In a second embodiment of the method, step a) comprises the sub-steps of:

i) loading the acid waste in dry form into a container and mixing the waste until homogenisation;

ii) adding water and the magnesium phosphate cement to the container; and simultaneously or successively

iii) mixing the acid waste with the water and the magnesium phosphate cement until homogenisation, whereby the cement paste is obtained.

Here, too, the water-soluble phosphate source, which is contained in the magnesium phosphate cement, and the water, can be added to the container separately or in the form of a solution previously prepared by dissolving the phosphate source in this water.

If one or more admixtures and/or sand and/or gravel are to be used, these can be added to the container at the same time as the water and the magnesium phosphate cement, and can be mixed with the acid waste, the water and the cement at sub-step iii).

In a third embodiment of the method, step a) comprises the sub-steps of:

i) loading the acid waste in wetted, semi-liquid or liquid form into a container and mixing until homogenisation;

ii) adding the magnesium phosphate cement to the container and mixing the cement with the acid waste until a homogenous mixture is obtained;

iii) optionally adding water to the container (if the total amount of water required for mixing the magnesium phosphate cement is not contained in the acid waste), and, simultaneously or successively, mixing the mixture obtained at sub-step ii) with the water until homogenisation, whereby the cement paste is obtained.

If one or more admixtures and/or sand and/or gravel are to be used, these can be added to the container at the same time as the magnesium phosphate cement and can be mixed with the cement and the acid waste at sub-step ii).

In a fourth embodiment of the method, step a) comprises the sub-steps of:

i) loading the acid waste in wetted, semi-liquid or liquid form into a container and mixing the waste until homogenisation;

ii) adding the sand and/or gravel to the container and mixing the waste with the sand and/or gravel until a homogeneous mixture is obtained;

iii) adding water and the magnesium phosphate cement to the container; and simultaneously or successively

iv) mixing the mixture obtained at sub-step ii), with the water and the magnesium phosphate cement until homogenisation, whereby the cement paste is obtained.

Here, too, the water-soluble phosphate source, which is contained in the magnesium phosphate cement, and the water can be added to the container separately or in the form of a solution previously prepared by dissolving the phosphate source in this water.

If one or more admixtures are to be used, these can be added to the container at the same time as the water and the magnesium phosphate cement, and can be mixed at sub-step iv) with the mixture obtained at sub-step ii), the water and the cement.

In a fifth embodiment of the method, step a) comprises the sub-steps of:

i) loading the magnesium phosphate cement into a first container and mixing the cement until homogenisation;

ii) loading water and the acid waste in dry, wetted, semi-liquid or liquid form into a second container, and mixing the water with the waste until a homogenous mixture is obtained;

iii) transferring the mixture obtained at sub-step ii) from the second container to the first container, and simultaneously or successively

iv) mixing the magnesium phosphate cement with the mixture obtained at sub-step ii) until homogenisation, whereby the cement paste is obtained.

If admixtures and/or sand and/or gravel are to be used, these can be added to the first container at the same time as the magnesium phosphate cement and can be mixed with this cement at sub-step i).

Irrespective of the manner in which step a) is performed, the mixing operations can be carried out using a mechanical mixer such as a mixer device with one or more rotating impellers.

In addition, irrespective of the manner in which step a) is performed, the container in which this step is carried out may or may not be a container also to be used as conditioning drum.

Therefore, the method may additionally comprise, between steps a) and b), a step of draining the container in which:
either step a) is carried out, if this step is entirely carried out in a single container,
or the last sub-step of step a) is carried out, if this step is carried out using different containers as in the fifth embodiment of the method described above, into a conditioning drum.

The hardening of the cement paste, or step b), can be obtained by storing the conditioning drum at ambient temperature and under controlled hygrometry conditions.

This conditioning drum is hermetically sealed either between step a) and step b) or after step b).

As previously indicated, the acid waste is selected from among liquids having a pH of no more than 4, semi-liquids having a pH of no more than 4, solids of which the partial (if these solids contain insoluble matter) or total dissolution in water leads to a solution or suspension having a pH of no more than 4, or a mixture thereof.

If it is liquid, the acid waste can notably comprise or be composed of:
an aqueous solution of sulfuric acid such as an aqueous effluent issued from the leaching of a uranium ore by sulfuric acid; or
an aqueous solution of phosphoric acid such as an aqueous effluent issued from the leaching of a natural phosphate by sulfuric acid; or
an aqueous solution of nitric acid such as an aqueous effluent issued from the refining of natural uranium concentrates or from the treatment of spent nuclear fuels; or
an aqueous solution of sulfuric, phosphoric, nitric, hydrochloric and/or hydrofluoric acid such as an aqueous effluent issued from the decontamination of nuclear plants; or
a mixture thereof.

If it is semi-liquid, the acid waste may notably comprise or be composed of a sludge such as:
a sludge of uranium diuranate issued from uranium conversion operations; or
a sludge of ion exchange resins; or
a mixture thereof.

If it is solid, the acid waste may notably comprise or be composed of:
rubble issued from dismantling operations of nuclear plants; or
water-soluble corrosion deposits; or
solid residues issued from the drying of decontamination gels; or
a mixture thereof.

In all cases, the acid waste preferably represents from 5% to 70% by mass of the mass of the cement paste.

If the acid waste is a solid waste, then the method may additionally comprise a preliminary treatment to reduce the dimensions of this waste, for example mechanical treatment of crushing, fragmenting type or the like.

The method of the invention has numerous advantages notably including simplification and shortening of the conditioning time for cementing acid waste, and thereby allowing savings in time, energy and reactants without affecting the quality of the conditioning packages obtained.

Other characteristics and advantages of the method of the invention will become apparent from the following additional description referring to examples of embodiment of this method for cementing aqueous acid solutions and acid sludge.

This additional description is evidently given solely to illustrate the subject of the invention and is not to be construed as limiting this subject-matter.

### BRIEF DESCRIPTION OF THE FIGURES

FIG. 1 illustrates the change in setting time, denoted t and expressed in minutes, of mortars based on a magnesium phosphate cement that have been mixed with an aqueous solution either of nitric acid or solely composed of water, as a function of the pH of this aqueous solution; in this Figure, curve A corresponds the onset of mortar setting whilst curve B corresponds to the end of mortar setting.

FIG. 2 illustrates the change in reaction heat, denoted Q and expressed in J/g, of mortars based on a magnesium phosphate cement that have been mixed with an aqueous solution either of nitric acid or solely composed of water, as a function of time denoted t and expressed in hours; in this Figure, curve A corresponds to a mortar mixed with an aqueous solution comprising 0.1 mol/L of nitric acid (pH 1); curve B corresponds to a mortar mixed with an aqueous solution comprising 3 mol/L of nitric acid (pH≈−0.5), whilst curve C corresponds to a mortar mixed with water.

FIG. 3 illustrates the change in compression strength, denoted R and expressed in MPa, of mortars based on a magnesium phosphate cement that have been mixed with an aqueous solution either of nitric acid or composed solely of water, as a function of the pH of this aqueous solution.

FIG. 4 illustrates the curves of differential thermal analysis (or DTA curves) of mortars based on a magnesium phosphate cement that have been mixed with an aqueous solution either of nitric acid or composed solely of water, as a function of the pH of this aqueous solution; in this Figure, the heat flow, denoted Φ and expressed in μV/mg, is given along the Y-axis whilst the temperature denoted Φ and expressed in ° C., is given along the X-axis.

FIG. 5 gives the X-ray diffraction diagrams of mortars based on a magnesium phosphate cement that have been mixed with an aqueous solution either of nitric acid or composed solely of water; in these diagrams, the letter q indicates the presence of quartz, the letter k indicates the presence of k-struvite, whilst the letter m indicates the presence of magnesium oxide.

FIG. 6 illustrates the change in compression strength, denoted R and expressed in MPa, of mortars based on a magnesium phosphate cement that have been mixed with an aqueous solution either of sulfuric acid or solely composed of water, as a function of the pH of this aqueous solution.

FIG. 7 gives the DTA curves of mortars based on a magnesium phosphate cement that have been mixed with an aqueous solution either of sulfuric acid or composed solely of water, as a function of the pH of this aqueous solution; in this Figure the heat flow, denoted Φ and expressed in μV/mg, is given along the Y-axis, whilst the temperature, denoted θ and expressed in ° C., is given along the X-axis.

FIG. 8 gives the X-ray diffraction diagrams of mortars based on a magnesium phosphate cement that have been mixed with an aqueous solution either of sulfuric acid or composed solely of water; in these diagrams the letter q indicates the presence of quartz, the letter k indicates the presence of k-struvite, whilst the letter m indicates the presence of magnesium oxide.

FIG. 9 illustrates the change in compression strength, denoted R and expressed in MPa, as a function of time denoted t and expressed in days, of a first mortar based on a magnesium phosphate cement comprising an acid sludge, and for comparison a second mortar only differing from the first in that it is devoid of acid sludge; in this Figure, the curves A and B correspond to two different samples of the first mortar whilst curve C corresponds to a sample of the second mortar.

### DETAILED DESCRIPTION OF PARTICULAR EMBODIMENTS

### Example 1: Cementation of Nitric Acid

A first series of mortars was prepared having the composition and characteristics given in Table 1 below.

TABLE I

| Components | | Mg/P | water/cement | sand/cement |
|---|---|---|---|---|
| (mass %) | | (mol/mol) | (m/m) | (m/m) |
| MgO (DBM 90) | 26 | 5 | 0.30 | 1 |
| KH₂PO₄ | 17 | | | |
| Borax | 1 | | | |
| Sand CV32 (Sibelco) | 43 | | | |
| Water | 13 | | | |

For doing that, the solid constituents of these mortars (i.e. MgO, KH₂PO₄, borax and sand) were first mixed together in a mixer for 2 minutes to obtain a homogenous mixture, and the mixture thus obtained was mixed with an aqueous mixing solution for 30 seconds at slow speed, then 30 seconds at rapid speed and finally for 1 minute at slow speed.

Six different aqueous mixing solutions were used, namely:
five solutions comprising nitric acid in respective proportions of 0.003 mol/L (pH≈2.5), 0.01 mol/L (pH 2), 0.1 mol/L (pH 1), 1 mol/L (pH 0) and 3 mol/L (pH≈−0.5); and
a solution solely composed of water (pH 7) to provide a reference mortar.

The mortars were subjected to:
setting time measurements, performed with a Vicat instrument in accordance with standard NF EN 196-3+A1 (Methods of testing cement. Part 3: Determination of the setting time and soundness); and
measurements of reaction heat (or heat of hydration) over a period of 150 hours, performed using a Langavant calorimeter in accordance with standard NF EN 196-9 (Methods of testing cements. Part 9: Heat of hydration, semi-adiabatic method).

After hardening, they were also subjected to:
measurements of compression strength, performed using a mortar press on prismatic test specimens of 4 cm×4 cm×16 cm, in accordance with standard NF EN 196-1 (Methods of testing cements. Part 1: Determination of mechanical strengths); and
differential thermal analyses (DTA).

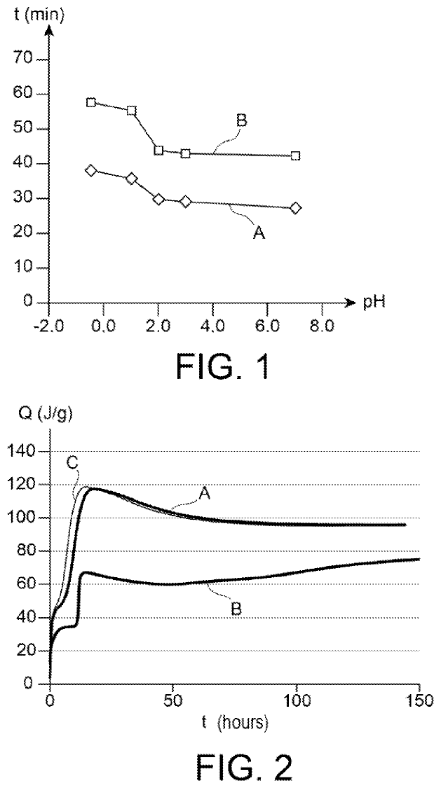

The results of these measurements and DTA are shown in FIGS. 1 to 4.

FIGS. 1 to 3 show that the presence of nitric acid in the aqueous mixing solutions:

1° has no notable negative impact on the setting time of mortars for solutions having a pH equal to or higher than 2 (i.e. a concentration of nitric acid equal to or lower than 0.01 mol/L); on the other hand, an increase in setting time is observed for solutions having a pH equal to lower than 1 (cf. FIG. 1);

2° leads to a reduction in the heat of hydration of mortars when the acid concentration of the aqueous solution is increased (cf. FIG. 2); and

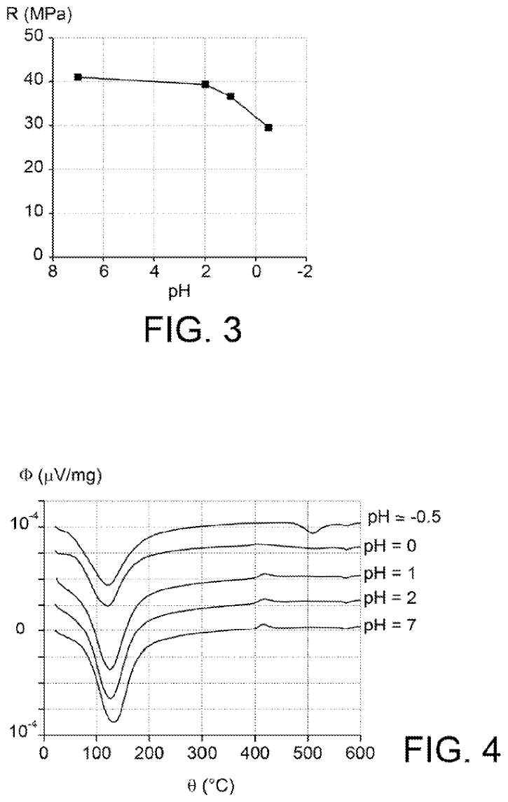

3° induces a reduction in the compressive strength of mortars but that, irrespective of the nitric acid concentration, the compressive strength obtained is greater than 8 MPa which represents the desired minimum value of compressive strength (cf. FIG. 3).

FIG. 4 shows that a first endothermal peak, positioned between 120° C. and 135° C. and corresponding to dehydration of k-struvite (representing the binder phase of magnesium phosphate cements derived from the reaction between MgO and KH₂PO₄), is common to all the mortars even if it is ascertained that the mass loss associated with this peak becomes more and more smaller as the nitric acid concentration of the aqueous mixing solution increases.

After hardening, the mortars were also characterized by X-ray diffraction (XRD).

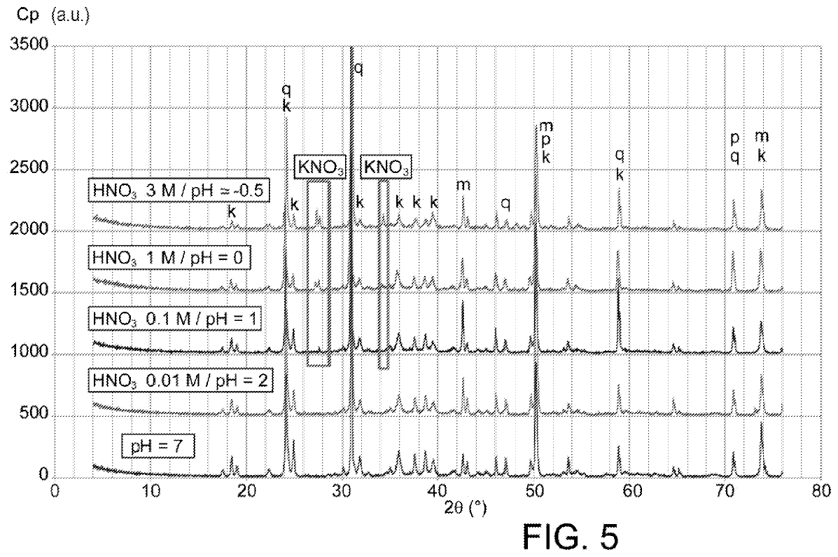

As shown in FIG. 5, the reference mortar is composed of the following crystalline phases:
a phase corresponding to quartz (subscript q), which represents the main phase of the mortar and is derived from the sand,
a phase corresponding to k-struvite (subscript k) previously mentioned, and
the remaining MgO (subscript m) since only about 15 mass % of the MgO added to the mortar are consumed at the time of k-struvite formation.

FIG. 5 also shows that on and after a nitric acid concentration of 0.1 mol/L (pH 1), characteristic peaks of potassium nitrate (KNO₃) occur at the following 2θ angle values: 27.2°; 27.6°; and 34.1°.

No trace of KH₂PO₄ is observed in the XRD diagram of the reference mortar, suggesting that this compound is fully consumed at the time of k-struvite formation.

Therefore, the addition of nitric acid to a mortar at the time of preparation thereof induces the formation of potassium nitrate.

The present example shows that the cementation of highly to very highly acidic waste produced by industrial processes using nitric acid, such as aqueous effluents derived from the refining of natural uranium concentrates or from the treatment of spent nuclear fuels, can be carried out directly, i.e. without any prior treatment of this waste intended to reduce the acidity thereof, and without shortening the setting time and without increasing the reaction heat.

A light reduction in mechanical properties is observed with an increase in nitric acid concentration. This is due to the fact that, since potassium dihydrogen phosphate reacts with nitric acid, it is partially consumed by this reaction and is hence less available to react with the magnesium oxide and to form k-struvite with the latter. An increase in the amount of phosphoric acid salt, in this case KH₂PO₄, incorporated in the cement paste, mortar or concrete should be sufficient to overcome this phenomenon.

### Example 2: Cementation of Sulfuric Acid

A second series of mortars was prepared having the composition and characteristics given in Table 1 above, following the same operating protocol as indicated in Example 1 but using as mixing solution:
three aqueous solutions comprising sulfuric acid in respective proportions of 0.1 mol/L (pH 1), 1 mol/L (pH 0) and 3 mol/L (pH≈−0.5); and
a solution composed solely of water (pH 7), also to provide a reference mortar.

The mortars were subjected to measurements of setting time performed in the same manner as in Example 1 and, after hardening, to compressive strength measurements and DTA also performed in the same manner as in Example 1.

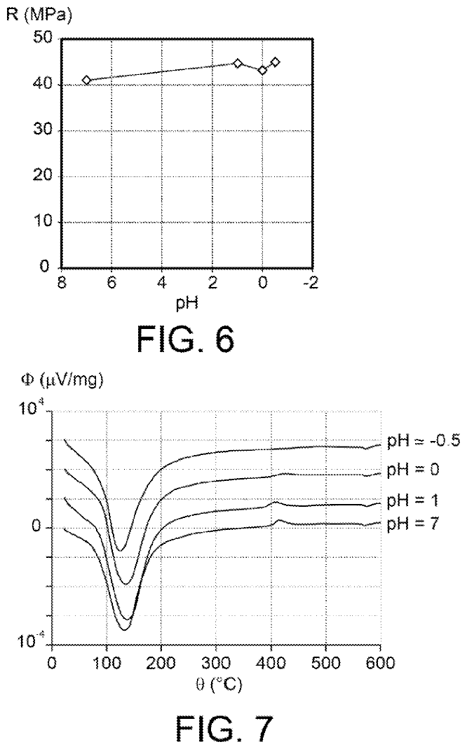

The results of the setting time measurements are given in Table II below, whilst the results of the compressive strength measurements and DTA are given in FIGS. 6 and 7.

TABLE II

| | Setting time (min) | |
|---|---|---|
| pH | Onset | End |
| 7 | 27.4 | 42.4 |
| 1 | 17 | 30 |
| 0 | 42 | 72 |
| ≈−0.5 | 27 | 47 |

This Table and FIGS. 6 and 7 show that the presence of sulfuric acid in the mortars does not have any notable impact on the setting time of the mortars or on their compressive strength or on the amount of k-struvite formed during hardening of the mortars.

After hardening, the mortars were also characterized by XRD.

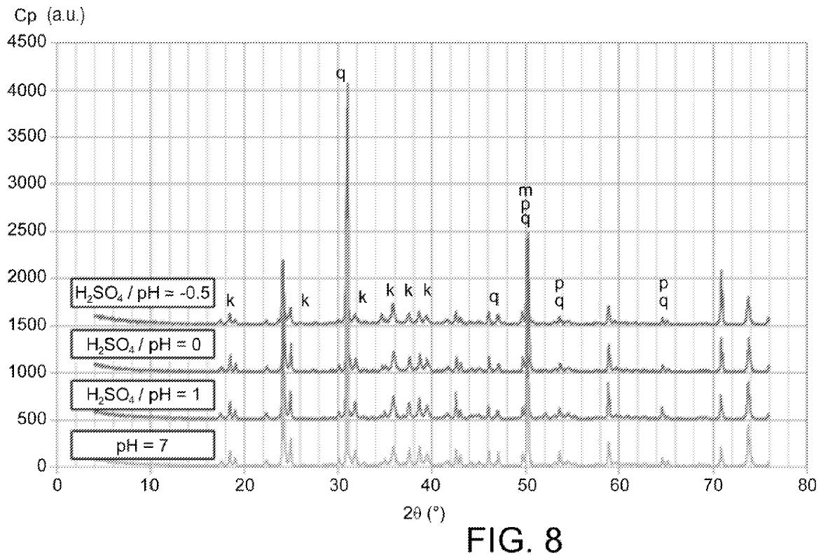

As shown in FIG. 8, the presence of sulfuric acid in a mortar does not appear to have any visible effect on the crystalline phases of the mortar, even with a sulfuric acid concentration of 3 mol/L. No phase onset is ascertained.

### Example 3: Cementation of a Sludge Containing Hydrofluoric Acid

A sludge containing hydrofluoric acid was cemented proceeding as follows.

First, corrosion products in the form powdery flakes and comprising on average: 17.6 mass % of fluorine, 4.4 mass % of nickel, 9.8 mass % of iron, 15.6 mass % of uranyl fluoride (UO₂F₂) and 33.3 mass % of uranium tetrafluoride (UF₄), were mixed with water in a mass ratio of 1 to prevent any dispersion of the flakes into the surrounding atmosphere.

An acid sludge was obtained of pH 2 since the UF₄ contained in the flakes reacts with water to release hydrofluoric acid following the equation:

UF₄+2H₂O→UO₂+4HF.

A first mortar was then prepared having the composition and characteristics given in Table III below.

TABLE III

| Components | | Mg/P | water/cement | sand/cement |
|---|---|---|---|---|
| (mass %) | | (mol/mol) | (m/m) | (m/m) |
| Sludge (flakes + water) | 35 | 5.1 | 0.52 | 0.5 |
| MgO (DBM 90) | 24 | | | |
| KH₂PO₄ | 16 | | | |
| Borax | 1 | | | |
| Sand CV32 (Sibelco) | 20 | | | |
| Additional water | 4 | | | |

For doing that, the solid constituents of the mortar (i.e. MgO, KH₂PO₄, borax and sand) and the additional water were first mixed together in a mixer until homogenisation, after which the acid sludge was added to the mixer and the whole was mixed until homogenisation.

As reference, a second mortar was prepared of same composition and characteristics as the first mortar with the exception that it was free of corrosion products, i.e. flakes.

No notable difference was observed in terms of setting time and reaction heat between the first and second mortars.

After hardening of the mortars, the latter were cut into samples of cubic shape with sides of 4 cm and these samples were subjected to compressive strength tests using a manual press.

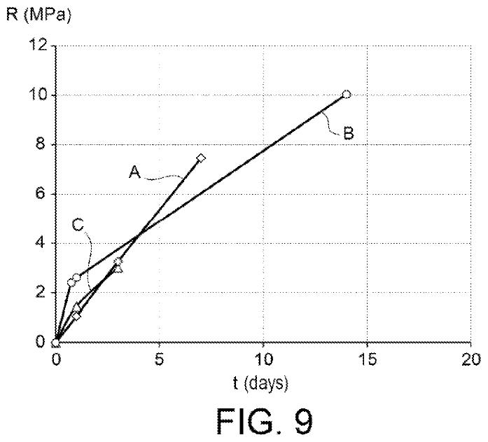

The results of these tests are given in FIG. 9 where the curves A and B correspond to two different samples of the first mortar, whilst curve C corresponds to a sample of the second mortar.

The water/cement mass ratio of the first and second mortars was high since it is 0.52, the effect of which is to reduce the compressive strength, an effect which is notoriously known for all cement materials and, in particular, for materials based on magnesium phosphate cements.

On the other hand, FIG. 9 shows that the presence of a highly acidic sludge in the first mortar has no notable impact on the values of compressive strength obtained for this mortar.

### CITED REFERENCES

[1] C. Utton and I. H. Godfrey, Report by the National Nuclear Laboratory NNL (09) 10212, 29 Jan. 2010
[2] International application PCT WO 2004/075207

What is claimed is:

1. A method for conditioning an acid waste by cementation, the acid waste being a liquid having a pH of no more than 4, a semi-liquid having a pH of no more than 4, a solid of which a partial or full dissolution in water leads to a solution or suspension having a pH of no more than 4, or a mixture thereof, which comprises the steps of:
a) preparing a cement paste having as components at least a magnesium phosphate cement and the acid waste, and
b) hardening the cement paste thus obtained,
and wherein at step a), the cement paste is prepared without subjecting beforehand the acid waste to any treatment consisting in reducing the acidity of the acid waste.

2. The method of claim 1, wherein the magnesium phosphate cement comprises magnesium oxide and a phosphoric acid salt in a Mg/P molar ratio of between 1 and 12.

3. The method of claim 2, wherein the phosphoric acid salt is potassium dihydrogen phosphate.

4. The method of claim 1, wherein the cement paste further comprises at least one superplasticizers or setting retarder.

5. The method of claim 4, wherein the cement paste comprises at least one of hydrofluoric acid, sodium fluoride, boric acid or sodium borate.

6. The method of claim 1, wherein the cement paste further comprises at least one of sand and gravel.

7. The method of claim 1, wherein the cement paste has a water/magnesium phosphate cement mass ratio of 0.10 to 1.

8. The method of claim 1, wherein step a) comprises:
i) loading the magnesium phosphate cement and water into a container and mixing the cement and water until a homogeneous mixture is obtained;
ii) adding the acid waste in dry, wetted, semi-liquid or liquid form to the container; and simultaneously or successively
iii) mixing the mixture obtained at i) with the acid waste until homogenisation, whereby the cement paste is obtained.

9. The method of claim 1, wherein step a) comprises:
i) loading the acid waste in dry form into a container and mixing the waste until homogenisation;
ii) adding water and the magnesium phosphate cement to the container; and simultaneously or successively
iii) mixing the acid waste with the water and the magnesium phosphate cement until homogenisation, whereby the cement paste is obtained.

10. The method of claim 1, wherein step a) comprises:
i) loading the acid waste in wetted, semi-liquid or liquid form into a container and mixing the latter until homogenisation;
ii) adding the magnesium phosphate cement to the container and mixing the cement with the acid waste until a homogenous mixture is obtained;
iii) optionally adding water to the container and, simultaneously or successively, mixing the mixture obtained at ii) with the water until homogenisation, whereby the cement paste is obtained.

11. The method of claim 1, wherein step a) comprises:
i) loading the acid waste in wetted, semi-liquid or liquid form into a container and mixing the waste until homogenisation;
ii) adding at least one of sand and gravel to the container and mixing the waste with the at least one of sand and gravel until a homogeneous mixture is obtained;
iii) adding water and the magnesium phosphate cement to the container; and simultaneously or successively
iv) mixing the mixture obtained at ii) with the water and the magnesium phosphate cement until homogenisation, whereby the cement paste is obtained.

12. The method of claim 1, wherein step a) comprises:
i) loading the magnesium phosphate cement into a first container and mixing the cement until homogenisation;
ii) loading water and the acid waste in dry, wetted, semi-liquid or liquid form into a second container and mixing the water with the waste until a homogenous mixture is obtained;
iii) transferring the mixture obtained at ii) from the second container to the first container; and simultaneously or successively
iv) mixing the magnesium phosphate cement with the mixture obtained at sub-step ii) until homogenisation, whereby the cement paste is obtained.

13. The method of claim 1, wherein the cement paste comprises from 5% to 70% by mass of the acid waste.

14. The method claim 1, wherein the acid waste is a waste produced by a nuclear industry.

15. The method of claim 14, wherein the acid waste is:
a waste issued from a process of mining extraction of uranium, conversion and enriching of uranium, production of fresh nuclear fuels or treatment of spent nuclear fuels;
a waste issued from a decontamination of nuclear cycle equipment and plants, or of nuclear reactors;
a waste issued from a remediation-dismantling of nuclear plants; or
a mixture thereof.

16. The method of claim 2, wherein the Mg/P molar ratio is between 5 and 10.

17. The method of claim 7, wherein the water/magnesium phosphate cement mass ratio is of from 0.20 to 0.60.
